(19) United States
(12) Patent Application Publication
(10) Pub. No.: US 2003/0087631 A1
(43) Pub. Date: May 8, 2003

(54) Controlling wireless mobile communications device transmitter for EM-sensitive environments

(76) Inventors: John W. Diachina, Garner, NC (US); Ron L. Bexten, Apex, NC (US)

Correspondence Address: COATS & BENNETT, PLLC, P O BOX 5, RALEIGH, NC, 27602, US

(21) Appl. No.: 09/991,621

(22) Filed: Nov. 5, 2001

(51) Int. Cl. H04M 3/42

(52) U.S. Cl. 455/414; 455/421; 455/422; 455/456

(57) ABSTRACT

An approach to managing a mobile communications device automatically disables the transmitter upon entry into an EM-sensitive environment. A wireless communications system responsible for a geographic area that includes a sensitive EM environment transmits a command message that instructs at least the mobile communications device entering the sensitive area to disable its transmitter. In response to the command message, the mobile communications device disables its transmitter and one of its two receivers or the mobile communications device disables its transmitter, but no receivers. In either case, the mobile communications device may still receive paging messages via the independent second receiver associated with a pager function and/or the primary receiver. The user may either be required to manually re-enable the transmitter, or the transmitter may be automatically re-enabled when the mobile communications device leaves the sensitive EM environment.

### BACKGROUND OF THE INVENTION

The present invention relates to wireless communications, and more particularly to a method of controlling the transmitter of a mobile communications device operating in or around an EM-sensitive environment.

A large number of people work at locations where medical care is provided, such as hospitals, nursing homes, and convalescent centers. The people who work in these facilities (e.g., doctors, nurses, administrators, maintenance personnel, etc.), as well as the patients themselves, are in an environment where there is typically a plethora of sophisticated medical equipment that might be sensitive to spurious electromagnetic (EM) radiation. As such, it is not uncommon for such facilities to require everyone to turn off all devices capable of emitting significant electromagnetic radiation upon entry. For instance, many hospitals require that mobile terminals (e.g., cellular phones) be turned off inside the hospital. However, people still desire to be reachable regardless of their physical location. As such, people who frequent such facilities on a regular basis typically also carry a pager along with their (disabled) mobile terminals. The dedicated pagers are allowed to function in such environments because the pagers have receive capability, but not transmit capability. This situation is less than ideal, as people find it inconvenient to carry two distinct physical devices. Further, such an arrangement still requires that the users remember to turn off their mobile terminals upon entry to such facilities.

### BRIEF SUMMARY OF THE INVENTION

The present invention provides an approach to managing the transmitter of a mobile communications device that automatically disables the transmitter upon entry into an EM-sensitive environment. A wireless communications system responsible for a geographic area that includes an EM-sensitive environment transmits a command message that instructs the mobile communications device entering the sensitive area to disable its transmitter. In one aspect of the invention, the mobile communications device disables its transmitter and one of its two receivers in response to the command message. In another aspect of the invention, the mobile communications device disables its transmitter, but no receivers in response to the command message. In either case, the mobile communications device may still receive paging messages via the independent second receiver associated with a pager function and/or the primary receiver. The user may either be required to manually re-enable the transmitter, or the transmitter may be automatically re-enabled when the mobile communications device leaves the EM-sensitive environment.

### BRIEF DESCRIPTION OF THE DRAWINGS

FIG. 1 shows a wireless communications system, including a localized wireless telephone system.

FIG. 2 shows a mobile communications device having wireless mobile terminal and wireless pager functionality.

FIG. 3 shows a typical EM-sensitive environment suitable for the present invention.

FIG. 4 shows a possible process flow according to the present invention.

FIG. 5 shows another possible process flow according to the present invention.

### DETAILED DESCRIPTION OF THE INVENTION

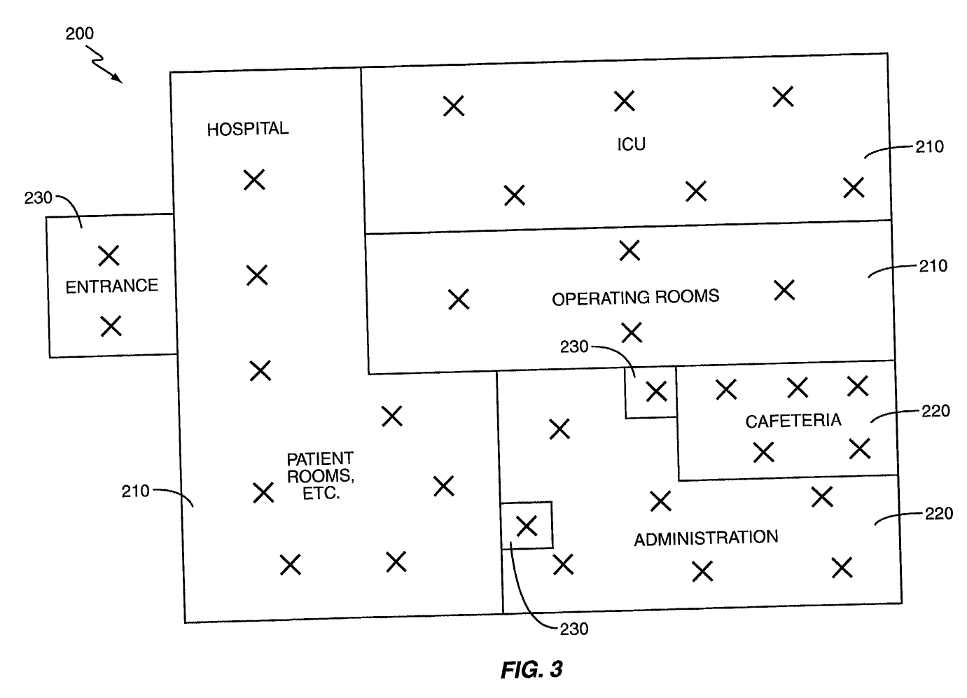

Hospitals, such as the one shown in the simplified representation of FIG. 3 discussed further below, are probably the most commonly encountered sensitive EM environments. As it is envisioned that the present invention will be applied most prevalently in hospitals equipped with a Localized Wireless Telephone System (LWTS), the following brief description of the LWTS may help in understanding the context of the present invention.

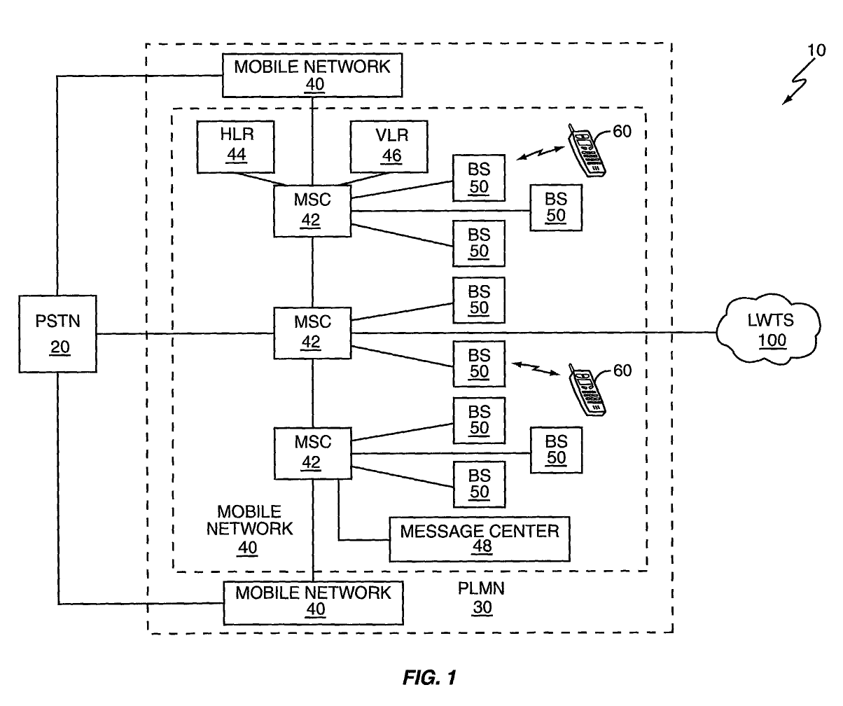

Turning now to FIG. 1, a communication system 10 is illustrated. In particular, the communications system 10 includes the Public Switched Telephone Network (PSTN) 20 and the Public Land Mobile Network (PLMN) 30, which may, in turn, be connected to one or more Localized Wireless Telephone Systems (LWTS) 100. The operation of the PSTN 20 is well established and subject to extensive documentation beyond the scope of the present invention and therefore a more detailed discussion thereof is omitted.

PLMN 30 may include a plurality of proprietary mobile networks 40, and each mobile network 40 may include a plurality of Mobile Switching Centers (MSC) 42. Typically, at least one MSC 42 in the PLMN 30, and more advantageously one MSC 42 in each mobile network 40, is connected via a gateway to the PSTN 20. Some MSCs 42 may also serve as gateways connecting the various mobile networks 40 within the PLMN 30. Gateway functions may be all consolidated at a single MSC 42 within a mobile network 40 or dispersed amongst a plurality of MSCs 42 within a mobile network 40 as needed or desired. Typically, at least one MSC 42 within a particular mobile network 40 connects to, or includes, a Home Location Register (HLR) 44 and a Visitor Location Register (VLR) 46, whose functions are well known in the art. Additionally, each mobile network 40 may be equipped with a message center 48 communicatively connected to an MSC 42 for handling short message service and the like. Each MSC 42 may further be communicatively connected to a plurality of base stations 50. Each base station 50 may be communicatively connected to one or more mobile terminals 60, typically over an RF communications channel.

The LWTS 100 is a wireless telecommunications system that may be public or private as needed or desired, and is typically a private network designed to cover a relatively small geographic area, such as a building or campus, using system transmit power levels that are substantially lower than those used in the conventional PLMN 30. LWTS 100 typically connects with an MSC 42 in the PLMN 30 to allow subscribers of the LWTS 100 to move seamlessly between the LWTS 100 and the PLMN 30. The MSC 42 responsible for a LWTS 100 may treat the LWTS 100 merely as another base station 50 or a plurality of base stations 50 depending on the internal structure of the LWTS 100 in question. Typically, the LWTS 100 includes a plurality of radio heads connected in one or more chains, with the end radio heads connected to an MSC 42. The physical connections between the various components of the LWTS 100 may take the form of a T1/E1 lines, typically with pulse code modulation, as is known in the art. The present invention adapts the general design and operation of the LWTS 100, otherwise known in the art, to better provide wireless communications service in EM-sensitive environments, such as in a hospital. One example of a suitable LWTS 100 that may be adapted according to the present invention is Mobile Advantage™ Wireless Office available from Ericsson, Inc.

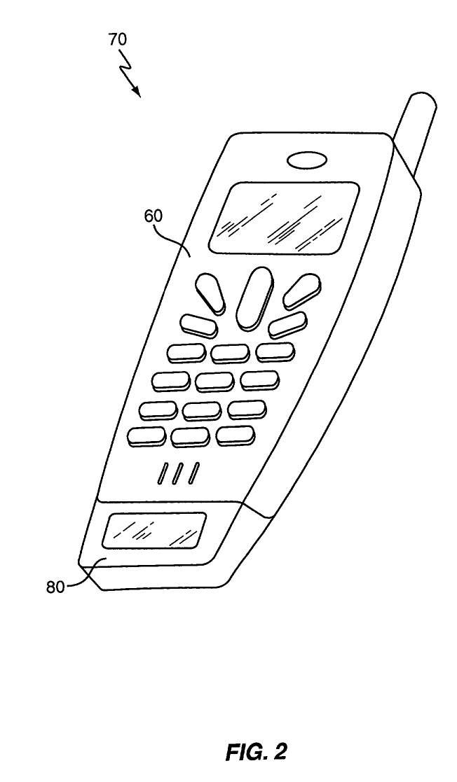

A first aspect of the present invention relates primarily to the operation of mobile communications devices 70 (see FIG. 2) that combine functionality of a mobile terminal 60 and functionality of a pager 80, within or around a sensitive EM environment. The mobile terminal 60 may take the form of a common cellular telephone, a personal digital assistant, or any other mobile wireless communications device with RF transmit and receive capability. The mobile terminal 60 may have a built-in pager functionality with RF receive capability but not transmit capability, typically using a separate receiver and power supply. Alternatively, the pager functionality may be supplied by a distinct pager unit 80 that is removably mounted to the housing of the mobile terminal 60, such as that shown in FIG. 2. The general concept of a combined mobile terminal and pager 70 is known in the art, see for example U.S. Pat. Nos. 6,188,907, 5,701,337 and 5,247,700, which are incorporated by reference. While combinations of mobile terminal and pager functionality have proven useful in some situations, they are less than ideal for operations in sensitive EM environments. This is primarily because prior art combinations still require the user to intervene and turn off the transmit capability of the mobile terminal 60 upon entry in to a sensitive EM environment.

As shown in FIG. 3, a hospital 200 may include a plurality of different type zones. For instance, there may be sensitive EM zones 210, such as patient rooms, intensive care units, operating rooms, and the like. There may also be some “safe” zones 220, such as the cafeteria, that are sufficiently EM isolated from the sensitive EM zones to allow RF transmissions. In addition, there may be dedicated entry areas 230 that provide transitions into the sensitive EM zones 210.

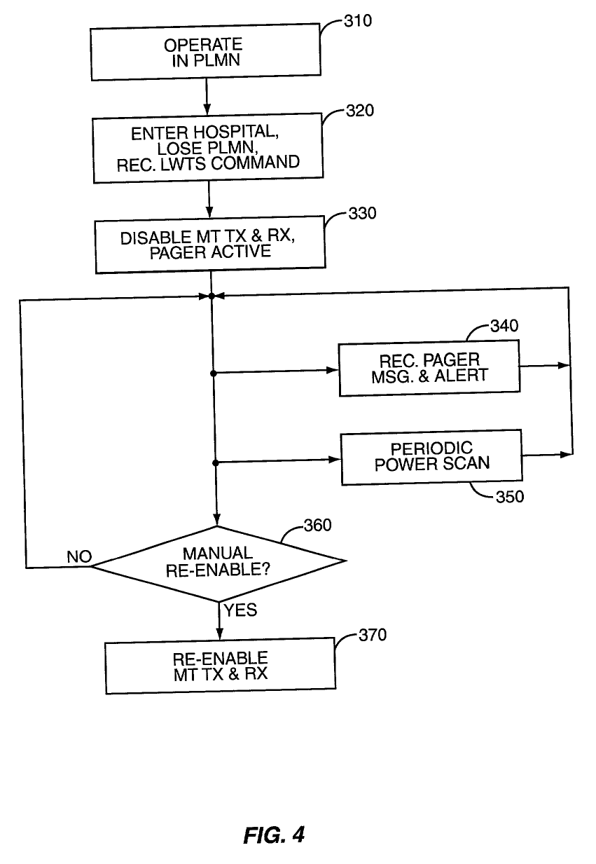

One process according the present invention may be that shown in FIG. 4. The process typically begins with a mobile communications device 70 operating in the PLMN 30 in any normal manner known in the art (box 310). The mobile communications device 70 should be registered with the PLMN 30, and may be camping or actively engaged in a call. The mobile communications device user enters the hospital 200 via the entry area 230 (box 320). The entry area 230 has been designed so that it effectively shields the mobile communications device 70 from the PLMN signals and also includes at least one transmit/receive antenna for the LWTS 100 (represented by X in FIG. 4). The LWTS 100 transmits a command message via this antenna that instructs the mobile communications device 70 to disable its transmit and receive functions associated with the mobile terminal functionality 60 (box 320). This “disable” command message from the LWTS 100 may be a portion of a broadcast signal carried on a control channel. The primary purpose of the “disable” command is to ensure that the mobile communications device 70 disables its transmitter without user intervention, which it does at box 330. The disabling of the transmitter may be achieved by turning-off the entire transmitter chain associated with the mobile terminal functionality 60, or just a portion thereof such as an RF power amplifier, or by decoupling the transmit circuitry from the antenna, or by any other means. Likewise, the disabling of the receiver may be achieved by turning-off the entire receiver chain associated with the mobile terminal functionality 60, or just a portion thereof such as an associated digital signal processor, or by decoupling the receiver circuitry from the antenna, or by any other means. While the one receive function of the mobile communications device 70 is also disabled, the other receive function—the one associated with the pager unit 80—is left on. Thereafter, the mobile communications device 70 may receive a paging message via the receive function associated with the pager unit 80 and alert the user via any known method (e.g., beep, vibrate, display, etc.) (box 340). The mobile communications device 70 also monitors for a manual re-enable command from the user (box 360). If the manual re-enable command is invoked, the mobile communications device 70 re-enables its transmit and receive functions associated with the mobile terminal functionality 60 (box 370). If the re-enable command is not invoked, the mobile communications device 70 continues monitoring for pager messages, command entry, etc. In addition, the mobile terminal functionality 60 may optionally periodically perform a power scan (box 350) so as to note potentially suitable base stations 50 within the PLMN 30 if the mobile communications device 70 were to leave the hospital 200; however, the mobile communications device 70 should not register with such base stations 50, as doing so would require transmitting while the “disable” state is in effect (i.e., “disable” command is presently invoked). While the user is in the hospital 200, the transmit and receive functions associated with the mobile terminal functionality 60 should remain generally disabled, excepting the optional periodic power scan, and be manually re-enabled when the user exits the hospital 200. Note also that the user may be able to manually re-enable the transmit and receive functions associated with the mobile terminal functionality 60 after entering a safe zone 220 within the hospital (e.g., the cafeteria); suitable entry zones 230 should be positioned within the hospital 200 such that the mobile communications device 70 must pass through an entry zone 230 before re-entering any EM-sensitive zones 210 when leaving a safe zone 220.

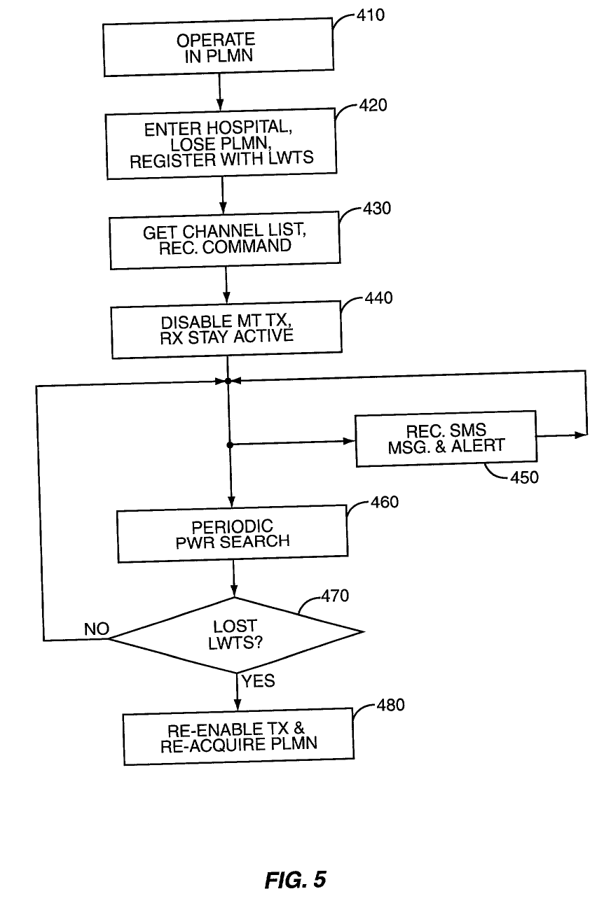

A second aspect of the present invention is advantageously adapted for use with mobile terminals 60 that are not necessarily associated with an independent pager 80. The process, shown in FIG. 5, begins with the mobile terminal 60 operating in the PLMN 30 in any normal manner known in the art (box 410). The mobile terminal 60 should be registered with the PLMN 30, and may be camping or actively engaged in a call. The mobile terminal user enters the hospital 200 via the entry area 230 (box 420). Due to the design of the entry area 230 shielding the mobile terminal 60 from the PLMN signals, the mobile terminal 60 loses the PLMN 30 while in the entry area 230, the mobile terminal 60 registers with the LWTS 100 (box 420). The LWTS 100 notifies the PLMN 30 of the registration, as appropriate. The LWTS 100 then sends the mobile terminal 60 a listing of its broadcast control channels (analogous to a neighbor list in the PLMN 30) and then transmits a command message that instructs the mobile terminal 60 to disable its transmitter, but not its receiver (box 430). This “disable” command message from the LWTS 100 may be a portion of broadcast message carried on one or all control channels. Alternatively, because the mobile terminal 60 has registered with the LWTS 100, the “disable” command message may be directed at that particular mobile terminal 60 in a point-to-point command message. The primary purpose of the “disable” command is ensure that the mobile terminal 60 disables its transmitter without user intervention, which the mobile terminal 60 does at box 440. The entry area 230 should be sized to allow sufficient time for the registration and the “disable” command to be executed. Thereafter, the mobile terminal 60 may receive a paging message via its receiver (box 450). For instance, the mobile terminal 60 may receive a Short Message Service (SMS) message at its receiver using methods known in the art. The paging message should be of the type that does not require an instantaneous, or quasi-instantaneous, acknowledgement, as the mobile terminal 60 should not transmit an acknowledgement while the “disable” state is in effect for that mobile terminal 60. In addition, the mobile terminal 60 periodically performs a power scan (e.g., an RSSI scan) (box 460) of the control channels provided by the LWTS 100 to confirm that the mobile terminal 60 is still within the geographic area controlled by the LWTS 100 (e.g., the hospital 200). If the LWTS 100 is providing sufficiently strong signal (box 470), the mobile terminal 60 returns to monitoring the appropriate channels for a paging message. If the signal strength from the LWTS 100 is insufficient (box 470), the mobile terminal 60 assumes that it has left the EM-sensitive area 200 and re-enables its transmitter and re-acquires the PLMN 30 (box 480). Note that this automatic re-enablement, or a manual re-enable command, may be used to allow normal PLMN communications upon leaving the hospital 200, or bi-directional communications via the LWTS 100 when the user enters a safe zone 220 within the hospital 200. For the case where a safe zone 220 has been entered, the mobile terminal 60 may be able to make this determination by detecting a sufficiently strong signal on a pre-designated frequency associated with the safe zone 220; this pre-designated frequency may be established upon first registering with the LWTS 100. The mobile terminal 60 may determine that it has left the hospital 200 when is not able to receive sufficient signal strength on any of the pre-designated frequencies established during registration with the LWTS 100. Once again, suitable entry zones 230 should be positioned such that the mobile terminal 60 must pass through an entry zone 230 before re-entering any EM-sensitive zones 210 when leaving a safe zone 220.

With the present invention, the user need not remember to disable the transmitter when entering an EM-sensitive area 210; this function is automatically performed. In addition, the mobile communications device 70 is not completely cut-off from the outside world, as the mobile communications device 70 may still receive paging messages via the independent pager function 80 and/or the built-in receive functions of the mobile terminal 60.

Because many hospitals provide wireless communications services through a system that typically transmits at substantially lower power than the conventional PLMN 30, a portion of a hospital 200 has been used as an illustrative example of an EM-sensitive environment 210 suitable for the present invention. However, the present invention is not limited thereto, and it may be used in any EM-sensitive environment. For example, other EM-sensitive environments may include blasting zones, aircraft, nuclear power plants, and the like.

The present invention may, of course, be carried out in other specific ways than those herein set forth without departing from the scope of the invention. The present embodiments are, therefore, to be considered in all respects as illustrative and not restrictive, and all changes coming within the meaning and equivalency range of the appended claims are intended to be embraced therein.

What is claimed is:

1. A method of controlling a wireless mobile communications device having transmit capability, a first receive capablility, and a second receive capability independent of said first receive capability, said method comprising:
receiving a command message at the mobile communications device, said command message from a first wireless communications system responsible for a geographic area comprising an EM-sensitive environment to mobile communications devices operating in said area instructing said mobile communications devices to disable their respective transmit and first receive capabilities; and
automatically disabling said transmit capability and said first receive capability of said mobile communications device without user intervention in response to said receiving said command message.

2. The method of claim 1 further comprising thereafter maintaining said transmit and said first receive capability as disabled until a user enters a re-enabling command.

3. The method of claim 1 wherein automatically disabling said transmit capability and said first receive capability of said mobile communications device without user intervention in response to said receiving said message comprises automatically disabling said transmit capability and said first receive capability of said mobile communications device without disabling said second receive capability in response to said receiving said message; and further comprising receiving, via said second receive capability, a paging message directed to said mobile communications device while said transmit and said first receive capability are disabled.

4. The method of claim 3 further comprising alerting the user to the receipt of said message.

5. The method of claim 1 further comprising registering said mobile communications device with a second wireless communications system different from said first wireless communications system prior to said receiving said command message.

6. The method of claim 5 further comprising moving said mobile communications device into said geographic area controlled by said first wireless communications system while said mobile communications device is registered with said second wireless communications system.

7. The method of claim 1 further comprising:
prior to receiving said command message, registering said mobile communications device with a second wireless communications system different from said first wireless communications system and moving said mobile communications device into said geographic area controlled by said first wireless communications system while said mobile communications device is registered with said second wireless communications system;
wherein automatically disabling said transmit capability and said first receive capability of said mobile communications device in response to said receiving said message comprises automatically disabling said transmit capability and said first receive capability of said mobile communications device without disabling said second receive capability in response to said receiving said message; and further comprising receiving, via said second receive capability, a paging message directed to said mobile communications device while said transmit and said first receive capability are disabled; and
maintaining said transmit and said first receive capability as disabled until a user enters a re-enabling command.

8. A method of controlling a wireless mobile communications device, comprising:
registering a first wireless mobile communications device with a first wireless communications system responsible for a geographic area comprising a sensitive EM environment; said first wireless mobile communications device having at least a transmitter;
transmitting a command message by said first wireless communications system to one or more mobile communications devices operating in said area, including said first mobile communications device, instructing said mobile communications devices to disable their respective transmitters;
receiving said command message at said first mobile communications device and automatically disabling said mobile communications device's transmitter without user intervention in response thereto; and
thereafter, receiving a paging message directed to said mobile communications device from said first wireless communications system at said mobile communications device while said transmitter is disabled.

9. The method of claim 8 further comprising detecting, by said first mobile communications device, a user activated re-enablement command, and, in response thereto, re-enabling at least said transmitter of said first wireless mobile communications device.

10. The method of claim 8 further comprising registering said first mobile communications device with a second wireless communications system different from said first wireless communications system prior to said receiving said command message.

11. The method of claim 10 further comprising said first mobile communications device automatically re-enabling said transmitter and registering with said second wireless communications system in response to exiting said geographic area of said first wireless communications system.

12. The method of claim 11 further comprising performing a power scan, by said first mobile communications device, and detecting an exit from said geographic area based on said power scan.
